(19) United States
(12) Patent Application Publication
(10) Pub. No.: US 2022/0317346 A1
(43) Pub. Date: Oct. 6, 2022

(54) OPTICAL MULTILAYER WITH BARRIER LAYER

(71) Applicant: META PLATFORMS TECHNOLOGIES, LLC, Menlo Park, CA (US)

(72) Inventors: Elliott Franke, Woodinville, WA (US); Nihar Ranjan Mohanty, Snoqualmie, WA (US); Vivek Gupta, Sammamish, WA (US); Geraud Jean-Michel Dubois, Redmond, WA (US)

(21) Appl. No.: 17/216,969

(22) Filed: Mar. 30, 2021

Related U.S. Application Data
(60) Provisional application No. 63/104,797, filed on Oct. 23, 2020.

(51) Int. Cl. G02B 5/18

(52) U.S. Cl. CPC G02B 5/1842; G02B 5/1866; G02B 5/1847

(57) ABSTRACT

A multilayer architecture includes an amorphous optical layer, a crystalline optical layer overlying the amorphous optical layer, and a barrier layer located between the amorphous optical layer and the crystalline optical layer. The barrier layer may be configured to mediate the structure of the later-formed amorphous optical layer. For instance, a low absorption barrier layer may be formed over the crystalline optical layer within the multilayer architecture and accordingly inhibit crystallization within a subsequently formed optical layer, thus providing phase separation between the neighboring optical layers and a desired refractive index gradient within the multilayer architecture without adversely affecting the optical path length therethrough. Such a multilayer structure may be configured as a light retention layer, antireflective coating, bandpass filter, etc.

### CROSS REFERENCE TO RELATED APPLICATION

This application claims the benefit of priority under 35 U.S.C. § 119(e) of U.S. Provisional Application No. 63/104,797, filed Oct. 23, 2020, the contents of which are incorporated herein by reference in their entirety.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a cross-sectional scanning electron microscope (SEM) image showing the merger of adjacent layers in a comparative optical multilayer according to some embodiments.

FIG. 2 is a cross-sectional scanning electron microscope (SEM) image showing a stack of discrete layers in an example optical multilayer according to some embodiments.

FIG. 3 is a schematic diagram illustrating a comparative method for manufacturing an optical multilayer according to certain embodiments.

FIG. 4 is a schematic diagram of an exemplary method for manufacturing an optical multilayer including a barrier layer according to some embodiments.

FIG. 5 is an illustration of exemplary augmented-reality glasses that may be used in connection with embodiments of this disclosure.

FIG. 6 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure relates generally to multilayer optical structures, and more particularly to multilayer architectures having plural discrete strata. According to example embodiments, two or more of the plural layers within a multilayer structure may be compositionally equivalent and yet exhibit a difference in refractive index. Such discrete layers may be separated by a thin barrier layer. As will be appreciated, multilayer optical structures may be used to manipulate light in conjunction with the operation of various devices, such as waveguides, lenses, polarizers, filters, and the like.

By way of example, a multilayer optical structure may be incorporated into a waveguide display, such as a near-eye display system. Near-eye light field displays may be used to project images directly into a user's eye, encompassing both near-eye displays (NEDs) and electronic viewfinders. Conventional near-eye displays (NEDs) typically have a display element that generates image light using a multicolored pixel array (including, e.g., red, green, and blue pixels) that passes through one or more lenses before reaching the user. The image light may be propagated laterally by a waveguide or other optical system so that the display element and the user's eye need not be aligned directly. Such waveguide displays may be used in head mounted displays (HMDs), for example, which may advantageously provide a large eye box, low pupil swim, and a thin form factor.

Undesirably, a number of loss mechanisms are typically associated with waveguide displays, including losses that accompany different positions, light ray angles, and wavelengths. These and other loss mechanisms can result in low system efficiency and color non-uniformity. One particular loss mechanism is associated with the input (i.e., diffraction) grating that couples light from a projector to be totally internally reflected within the waveguide. Notwithstanding recent developments, it would be advantageous to provide an improved input grating architecture that increases waveguide efficiency and improves color uniformity as well as an improved waveguide architecture, without compromising performance or limiting the field of view of the display.

In accordance with various embodiments, a thin barrier layer may be incorporated into a multilayer optical structure to mediate the morphology of one or more layers within the multilayer. For instance, a low absorption amorphous barrier layer may be formed over a crystalline optical layer within a multilayer stack and accordingly inhibit crystallization during the formation of a subsequently deposited optical layer, thus providing phase separation between adjacent optical layers and a desired refractive index gradient without adversely affecting the optical path length through the multilayer. That is, according to some embodiments, a barrier layer may be used to maintain spatial fidelity between neighboring layers of a multilayer structure and accordingly the refractive index integrity for an associated device. In particular embodiments, the barrier layer may facilitate the formation of a multilayer structure having an interlayer refractive index gradient and a uniform composition (i.e., amongst the various layers).

In some embodiments, the barrier layer may be configured as a functional coating that is adapted to regulate the transmittance therethrough of light and/or the transpiration therethrough of water, water vapor, or other liquids or gases. In certain embodiments, a barrier layer may be configured to inhibit the permeation of water vapor to less than approximately 10⁻⁶ g/m²/day and/or inhibit the permeation of oxygen to less than approximately 10⁻⁵ cm³/m²/day. According to further embodiments, a barrier layer may improve the mechanical robustness of a multilayer actuator, e.g., via crack blunting and/or vibration reduction. A barrier layer may be colorless, chemically inert, electrically insulating, and/or scratch resistant.

In certain embodiments, a multilayer optical structure may be located within the transparent aperture of an optical device such as a liquid lens, although the present disclosure is not particularly limited and may be applied in a broader context. By way of example, the multilayer optical structure may be incorporated into an active grating, tunable lens, accommodative optical element, adaptive optics, etc. According to various embodiments, the multilayer optical structure may be optically transparent.

As used herein, a material or element that is “transparent” or “optically transparent” may, for a given thickness, have a transmissivity within the visible light spectrum of at least approximately 60%, e.g., approximately 60, 70, 80, 90, 95, 97, 98, 99, or 99.5%, including ranges between any of the foregoing values, and less than approximately 10% bulk haze, e.g., approximately 0.1, 0.2, 0.5, 1, 2, 4, 6, or 8% bulk haze, including ranges between any of the foregoing values.

In accordance with some embodiments, for a given thickness, a “fully transparent” material or element may have a transmissivity (i.e., optical transmittance) within the visible light spectrum of at least approximately 90%, e.g., approximately 90, 95, 97, 98, 99, or 99.5%, including ranges between any of the foregoing values, less than approximately 10% bulk haze, e.g., approximately 0.1, 0.2, 0.5, 1, 2, 4, 6, or 8% bulk haze, including ranges between any of the foregoing values, less than approximately 10% reflectivity, e.g., approximately 1, 2, 5, or 10% reflectivity, including ranges between any of the foregoing values, and at least 70% optical clarity, e.g., approximately 70, 80, 90, 95, 97, 98, 99, or 99.5% optical clarity, including ranges between any of the foregoing values. Transparent and fully transparent materials will typically exhibit very low optical absorption and minimal optical scattering. A used herein, a layer having one or more of the foregoing characteristics (i.e., transmissivity, bulk haze, reflectivity, optical clarity, etc.) may be referred to as an “optical layer.”

As used herein, the term “approximately” in reference to a particular numeric value or range of values may, in certain embodiments, mean and include the stated value as well as all values within 10% of the stated value. Thus, by way of example, reference to the numeric value “50” as “approximately 50” may, in certain embodiments, include values equal to 50±5, i.e., values within the range 45 to 55.

As used herein, the terms “haze” and “clarity” may refer to an optical phenomenon associated with the transmission of light through a material, and may be attributed, for example, to the refraction of light within the material, e.g., due to secondary phases or porosity and/or the reflection of light from one or more surfaces of the material. As will be appreciated by those skilled in the art, haze may be associated with an amount of light that is subject to wide angle scattering (i.e., at an angle greater than 2.5° from normal) and a corresponding loss of transmissive contrast, whereas clarity may relate to an amount of light that is subject to narrow angle scattering (i.e., at an angle less than 2.5° from normal) and an attendant loss of optical sharpness or “see through quality.”

A multilayer structure in accordance with various embodiments may include a first amorphous optical layer, a crystalline optical layer overlying the first amorphous optical layer, and an amorphous barrier layer located between the first amorphous optical layer and the crystalline optical layer. In some embodiments, the amorphous barrier layer may be characterized as an optical layer.

The individual optical layers within a multilayer structure may have any suitable composition and thickness. According to some embodiments, a multilayer structure may include one or more dielectric layers, which may include a stoichiometric or non-stoichiometric oxide, fluoride, oxyfluoride, nitride, oxynitride, sulfide, including but not limited to SiO₂, TiO₂, Al₂O₃, Y₂O₃, HfO₂, ZrO₂, Nb₂O₅, Ta₂O₅, Cr₂O₃, AlF₃, MgF₂, NdF₃, LaF₃, YF₃, CeF₃, YbF₃, Si₃N₄, ZnS, or ZnSe.

In some embodiments, a multilayer structure may include combinations of one or more of the aforementioned oxides and/or one or more of the aforementioned fluorides. Example multilayer structures may include: (a) one of the above-identified oxides (i.e., plural layers of one of the above-identified oxides), (b) one of the above-identified fluorides (i.e., plural layers of one of the above-identified fluorides), (c) two of the above-identified oxides, or (d) one of the above-identified oxides combined with one of the above-identified fluorides. By way of example, a multilayer stack may include a layer of titanium oxide sandwiched between opposing layers of silicon dioxide.

Each layer (e.g., optical layer or barrier layer) within a multilayer structure may have a thickness ranging from approximately 2 nm to approximately 100 nm, e.g., 2, 5, 10, 20, 50, or 100 nm, including ranges between any of the foregoing values. In example structures, the barrier layer thickness may range from approximately 2 nm to approximately 10 nm, whereas the thickness of the optical layers may independently range from approximately 20 nm to approximately 100 nm. In some embodiments, a multilayer optical structure may be disposed over a solid substrate, e.g., a glass, semiconductor, or polymer substrate.

In order to mediate reflective losses and inhibit the creation of optical artifacts such as ghost images, example multilayer structures may form, or include, a reflective or antireflective coating (ARC). An antireflective coating may be configured to gradually decrease the refractive index between that of the substrate, for example, and an adjacent, typically lower index material, such as air. In various embodiments, an antireflective coating may include multiple layers of varying refractive index and/or one or more layers having an internal refractive index gradient.

Further multilayer structures may form, or be incorporated into, a waveguide such as a planar waveguide. A planar waveguide may include a tri-layer (e.g., ABA) architecture with an intermediate (B) layer having a refractive index that is greater than that of the surrounding (A) layers. Such a structure may channel light, i.e., within the intermediate layer, by total internal reflection.

Example optical layers may have a refractive index within the range of approximately 2.3 to approximately 2.8, e.g., 2.3, 2.4, 2.5, 2.6, 2.7, or 2.8, including ranges between any of the foregoing values, although optical layers having lesser or greater refractive indices are contemplated.

In some embodiments, a difference in the refractive index between adjacent optical layers in a multilayer structure may be at least approximately 0.2, e.g., 0.2, 0.3, 0.4, 0.5, 0.6, 0.7, 0.8, 0.9, or more, including ranges between any of the foregoing values. By way of example, in a tri-layer (ABA) multilayer structure, each A layer may have a refractive index in the range of 2.3-2.4, whereas the intervening B layer may have a refractive index in the range of 2.6-2.7. The refractive index of the barrier layer, which may be disposed between the B layer and the later-formed A layer, may be less than the refractive index of both the A layers and the B layer, or may be greater than the refractive index of the A layers but less than the refractive index of the B layer.

As described herein, the formation or deposition of a layer or structure, including the foregoing layers and structures, may involve one or more techniques suitable for the material or layer being deposited or the structure being formed. In addition to techniques or methods specifically mentioned, various techniques include, but are not limited to, chemical vapor deposition (CVD), atomic layer deposition (ALD), molecular beam epitaxy (MBE), electroplating, electroless plating, ion beam deposition, spin on coating, thermal oxidation, and physical vapor deposition (PVD) techniques such as sputtering or evaporation.

With various CVD processes, for example, a substrate may be exposed to one or more precursors, which may react and/or decompose on, over, or proximate to, the substrate surface to produce the desired layer (e.g., an optical layer or barrier layer).

In some embodiments, an optical layer or barrier layer may be fabricated over a substrate enclosed by a deposition chamber, which may be evacuated (e.g., using one or more mechanical vacuum pumps to a predetermined level such as 10⁻⁶ Torr or below). A substrate may include a high index (e.g., n>1.5) glass or polymer material, for example, or a high index semiconductor material such as zinc selenide or silicon carbide.

A deposition chamber may include a rigid material (e.g., steel, aluminum, brass, glass, acrylic, and the like) enclosing and defining a reaction volume. A deposition chamber may have an exhaust port configured to open to release at least a portion of reaction by-products, as well as monomers, oligomers, monomer initiators, etc. associated with the formation of one or more optical layers. In some embodiments, a deposition chamber may be purged (e.g., with a gas or the application of a vacuum, or both) to remove such materials. Thereafter, one or more deposition steps may be repeated (e.g., for a subsequent optical layer or barrier layer). In this way, individual layers of a multilayer structure may be maintained at high purity levels.

In some methods, a mask (e.g., shadow mask) may be used to control the geometry of one or more deposited layers. In further embodiments, methods for fabricating a multilayer architecture may include photolithographic techniques to pattern a deposited structure, e.g., by etching.

As will be appreciated, various chemical vapor deposition methods may be used to form a multilayer optical structure. In some embodiments, an optical layer may be fabricated using an atmospheric pressure CVD (APCVD) coating technique (e.g., CVD at atmospheric pressure). In further embodiments, an optical layer may be fabricated using a low-pressure CVD (LPCVD) process (e.g., CVD at sub-atmospheric pressures). In some embodiments, LPCVD may make use of reduced pressures that may inhibit unwanted gas-phase reactions and improve the deposited material's uniformity across a substrate. In one aspect, a fabrication apparatus may apply an ultrahigh vacuum CVD (UHVCVD) process (e.g., CVD at very low pressure, typically below approximately 10⁻⁶ Pa (equivalently, approximately 10⁻⁸ Torr)).

In some embodiments, an optical layer may be fabricated using an aerosol assisted CVD (AACVD) process (e.g., a CVD process in which the precursors are transported to the substrate using a liquid/gas aerosol). The aerosol may be generated ultrasonically or with electrospray. In some embodiments, AACVD may be used with non-volatile precursors. In some embodiments, an optical layer may be fabricated using a direct liquid injection CVD (DLI-CVD) process (e.g., a CVD process in which the precursors are in liquid form, for example, a liquid or solid dissolved in a solvent). Liquid solutions may be injected in a deposition chamber using one or more injectors. Precursor vapors may then be transported as in CVD. DLI-CVD may be used with liquid or solid precursors, and high growth rates for the deposited materials may be achieved using this technique.

In some embodiments, an optical layer may be fabricated using a hot wall CVD process (e.g., CVD in which the deposition chamber is heated by an external power source and the deposited layer(s) are heated by radiation from the heated wall of the deposition chamber). In another aspect, an optical layer may be fabricated using a cold wall CVD process (e.g., a CVD process in which only the substrate is directly heated, for example, by induction, while the walls of the chamber are maintained at room temperature).

In some embodiments, an optical layer may be fabricated using a microwave plasma-assisted CVD (MPCVD) process, where microwaves are used to enhance chemical reaction rates of the precursors. In another aspect, an optical layer may be fabricated using a plasma-enhanced CVD (PECVD) process (e.g., CVD that uses plasma to enhance chemical reaction rates of the precursors). In some embodiments, PECVD processing may allow deposition of materials at lower temperatures, which may be useful in withstanding damage to the substrate or in depositing certain materials (e.g., organic materials and/or some polymers).

In some embodiments, an optical layer may be fabricated using a remote plasma-enhanced CVD (RPECVD) process. In some embodiments, RPECVD may be similar to PECVD except that the optical layer may not be directly in the plasma discharge region. In some embodiments, the removal of the optical layer(s) from the plasma region may allow for lower processing temperatures down to approximately room temperature (i.e., approximately 23° C.).

In some embodiments, an optical layer may be fabricated using an atomic-layer CVD (ALCVD) process. ALCVD may deposit successive layers of different substances to produce layered, crystalline and/or amorphous thin films.

In some embodiments, an optical layer may be fabricated using a combustion chemical vapor deposition (CCVD) process. In some embodiments, CCVD (also referred to as flame pyrolysis) may refer to an open-atmosphere, flame-based technique for depositing high-quality thin films (e.g., layers of material ranging from fractions of a nanometer (monolayer) to several micrometers in thickness).

In some embodiments, an optical layer may be fabricated using a hot filament CVD (HFCVD) process, which may also be referred to as catalytic CVD (cat-CVD) or initiated CVD (i-CVD). This process may use a hot filament to chemically decompose source gases to form one or more layers of a multilayer structure. Moreover, the filament temperature and temperature of portions of the deposited layer(s) may be independently controlled, allowing colder temperatures for better adsorption rates at the growth surface, and higher temperatures to facilitate decomposition of precursors to free radicals at the filament.

In some embodiments, an optical layer may be fabricated using a hybrid physical-chemical vapor deposition (HPCVD) process. HPCVD may involve both chemical decomposition of precursor gas and vaporization of a solid source to form the materials of the optical layer/multilayer.

In some embodiments, an optical layer may be fabricated using a metalorganic chemical vapor deposition (MOCVD) process (e.g., a CVD method that uses metalorganic precursors to form one or more layers of a multilayer structure).

In some embodiments, an optical layer may be fabricated using a rapid thermal CVD (RTCVD) process. This CVD process uses heating lamps or other methods to rapidly heat the optical layer(s). Heating only the optical layer(s) during fabrication rather than the precursors or chamber walls may inhibit unwanted gas-phase reactions that may lead to particle formation in one or more layers of a multilayer structure.

In some embodiments, an optical layer may be fabricated using a photo-initiated CVD (PICVD) process. This process may use UV light to stimulate chemical reactions in the precursor materials used to make the materials for the optical layer(s). Under certain conditions, PICVD may be operated at or near atmospheric pressure.

Features from any of the embodiments described herein may be used in combination with one another in accordance with the general principles described herein. These and other embodiments, features, and advantages will be more fully understood upon reading the following detailed description in conjunction with the accompanying drawings and claims.

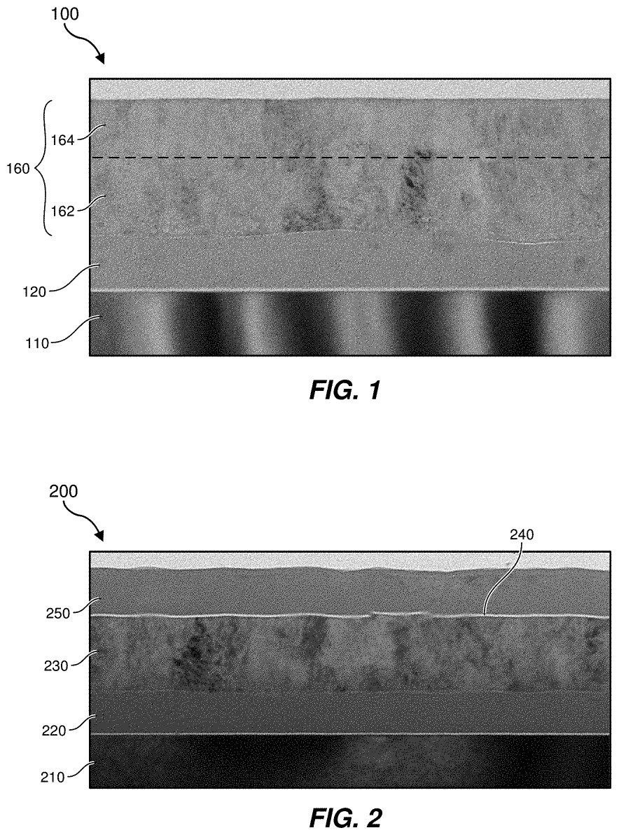

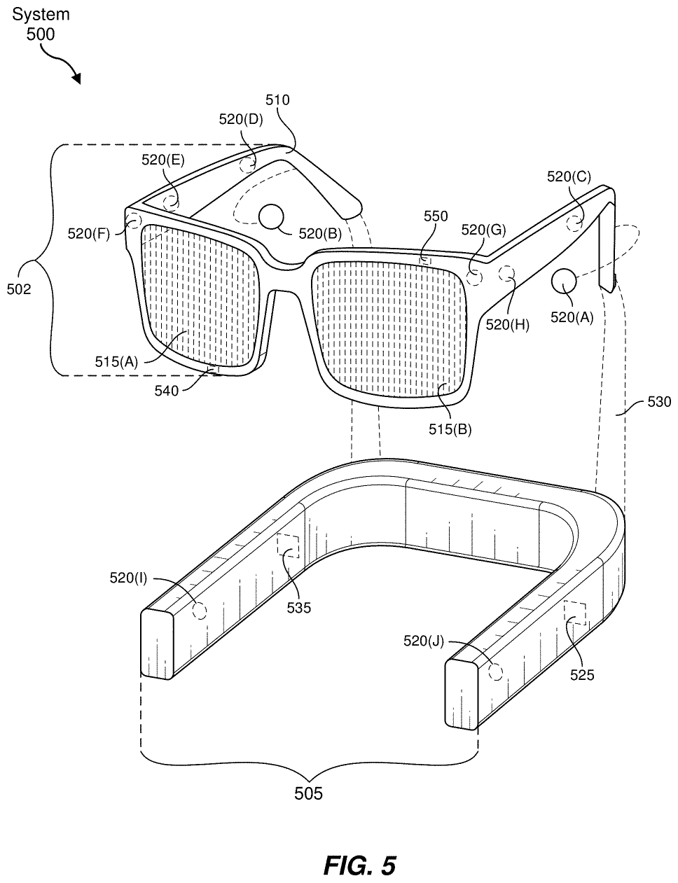

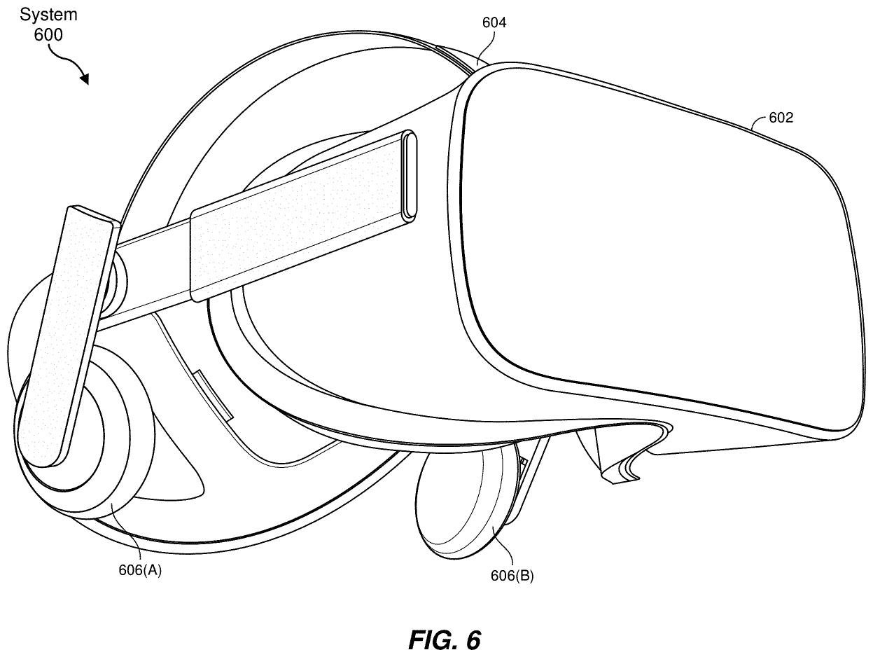

The following will provide, with reference to FIGS. 1-6, detailed descriptions of multilayer optical coatings and related methods of manufacture. The discussion associated with FIGS. 1-4 relates to the incorporation of a barrier layer into a multilayer structure having plural optical layers. The discussion associated with FIGS. 5 and 6 relates to exemplary virtual reality and augmented reality devices that may include a multilayer optical coating as disclosed herein.

A cross-sectional SEM micrograph of a comparative multilayer structure is shown in FIG. 1. Multilayer 100 is disposed over a substrate 110 and includes, from bottom to top, an amorphous optical layer 120 located over the substrate 110 and a crystalline optical layer 160 disposed over the amorphous optical layer 120. Crystalline optical layer 160 includes a primary crystalline sub-layer 162 and a secondary crystalline sub-layer 164. Primary crystalline sub-layer 162 is located directly over the amorphous optical layer 120 and secondary crystalline sub-layer 164 is located directly over the primary crystalline sub-layer 162.

During manufacture, respective layers of a multilayer structure may be formed in succession such that, according to some embodiments, an ABA tri-layer may include a first relatively low index A layer formed over a substrate, a relatively high index B layer formed over the first A layer, and a second relatively low index A layer formed over the B layer. The A and B layers may each include silicon dioxide, for example, where the lower index A layers may be amorphous layers while the higher index B layer may be at least partially crystalline. Such a structure may be suitable for forming a planar waveguide.

Referring again to FIG. 1, without wishing to be bound by theory, the crystalline nature of the B layer (i.e., primary crystalline sub-layer 162) may induce unwanted crystallization in the overlying layer (i.e., secondary crystalline sub-layer 164) during deposition thereof, resulting in the coalescence of the sub-layers 162, 164, which may disrupt the intended refractive index profile across the multilayer 100. A dashed line delineates the intended boundary between the primary crystalline sub-layer 162 and the overlying layer.

Turning to FIG. 2, shown is a cross-sectional SEM micrograph of an example multilayer optical structure. Multilayer optical structure 200 may be disposed over a substrate 210 and may include a first amorphous optical layer 220 disposed over the substrate 210, a crystalline optical layer 230 disposed over the first amorphous optical layer 220, an amorphous barrier layer 240 disposed over the crystalline optical layer 230, and a second amorphous optical layer 250 disposed over the amorphous barrier layer 240.

In contrast to the embodiment of FIG. 1, a thin, amorphous barrier layer 240 is incorporated into the multilayer architecture, e.g., over crystalline optical layer 230, such that an amorphous optical layer 250 may be formed over the crystalline optical layer 230. Barrier layer 240 thus facilitates the formation of a compositionally-uniform multilayer optical structure that includes a higher refractive index crystalline layer sandwiched between lower refractive index amorphous layers.

Further to the foregoing, a method may include forming a crystalline optical layer over a substrate, forming an amorphous barrier layer over the crystalline optical layer, and forming an amorphous optical layer directly over the amorphous barrier layer, where a composition of the crystalline optical layer and a composition of the amorphous optical layer may be substantially equivalent. The method may further include forming an amorphous optical layer over the substrate prior to forming the crystalline optical layer. Thus, a multilayer structure may include plural compositionally equivalent but structurally distinct layers.

According to some embodiments, a multilayer thin film may include an amorphous barrier layer disposed between a first amorphous optical layer and a crystalline optical layer, where a composition of the amorphous optical layer is substantially equivalent to a composition of the crystalline optical layer. In particular embodiments, such a multilayer thin film may further include a second amorphous optical layer disposed over the crystalline optical layer opposite to the amorphous barrier layer. In such embodiments, a composition of the second amorphous optical layer may be substantially equivalent to the composition of the first amorphous optical layer. In an example structure, a refractive index of the first amorphous optical layer may be substantially equal to a refractive index of the second amorphous optical layer, and a refractive index of the intervening crystalline optical layer may be greater than the refractive index of the amorphous optical layers.

As will be appreciated with reference to FIG. 1 and FIG. 2, a multilayer optical structure may be characterized by a planar or substantially planar architecture. According to further embodiments, a multilayer optical structure including an embedded barrier layer may be characterized by a structured (e.g., 3-D) architecture.

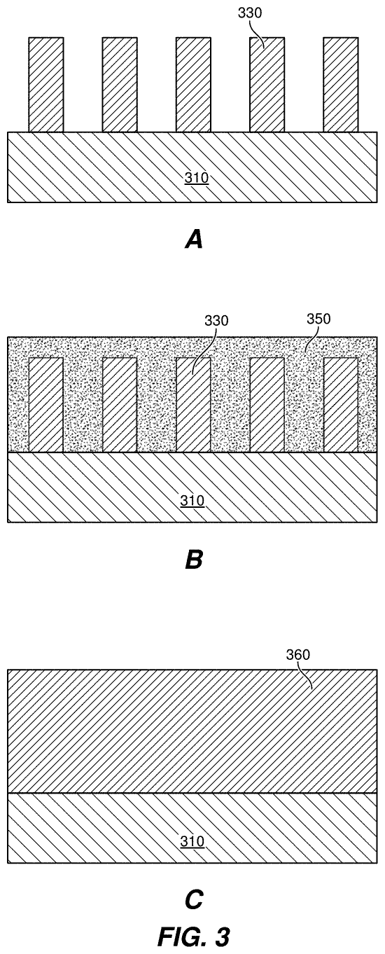

Shown schematically in FIG. 3 is a structured optical layer overlying a substrate. Referring to FIG. 3A, substrate 310 may include a transparent glass or polymer. Structured optical layer 330 may be formed by selective deposition or by blanket deposition followed by patterning and etching, and may include a dielectric material such as silicon dioxide or titanium oxide. The structured optical layer 330 may include an array of pillars or fins, for example.

Referring to FIG. 3B, an encapsulation layer 350 may be formed over the structured optical layer 330. Encapsulation layer 350 may include an optical layer. In some embodiments, a composition of the encapsulation layer 350 may be equivalent to a composition of the structured optical layer 330. During or subsequent to the formation of the encapsulation layer 350, however, and as shown in FIG. 3C, the encapsulation layer 350 and the structured optical layer 330 may coalesce or merge into a single phase, which results in an unintended loss of the structural fidelity of the optical layer.

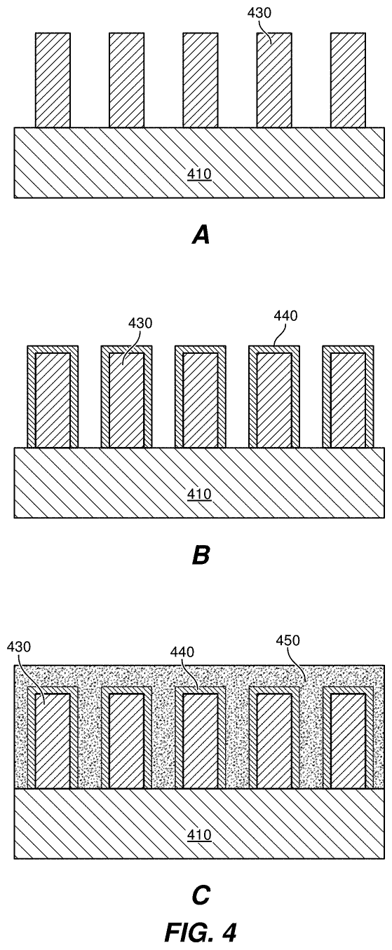

Turning to FIG. 4, shown schematically is a further example structured optical layer. Referring to FIG. 4A, structured optical layer 430 may be formed over a substrate 410 using a chemical vapor deposition (CVD) technique, for example, and patterned using photolithography and etching. As shown in FIG. 4B, a conformal barrier layer 440 may be formed over the structured optical layer 430 prior to forming an encapsulation layer 450, as illustrated in FIG. 4C. In certain embodiments, the structured optical layer 430 and the encapsulation layer 450 may be compositionally equivalent. Conformal barrier layer 440 may be adapted to maintain the geometric fidelity of the structured optical layer 430 during and following deposition of the encapsulation layer 450.

Conformal barrier layer 440 may be formed over exposed surfaces of the structured optical layer 430 using any suitable process, such as atomic layer deposition (ALD), chemical vapor deposition (CVD), physical vapor deposition (PVD), thermal oxidation, UV-ozone oxidation, or combinations thereof. According to certain embodiments, the ion energy during a physical vapor deposition (PVD) process may be controlled by modulating the substrate impedance. By varying the ion energy throughout the deposition process, geometric shadowing, angle-of-incidence, and sputtering effects inherent to line-of-sight deposition can be balanced to control the extent of conformality of the deposited layer over three-dimensional structures. The structure shown in FIG. 4C may be suitable for forming a diffraction grating.

As disclosed herein, a multilayer optical coating may be used to manipulate light in conjunction with the operation of various devices, such as waveguides, lenses, polarizers, filters, and the like. By way of example, according to various embodiments, a multilayer architecture may be configured to function as a light retention layer, antireflective coating, bandpass filter, etc. Individual layers within the multilayer architecture may be formed, e.g., in succession, using thin film deposition processes such as chemical vapor deposition, physical vapor deposition, or atomic layer deposition, where characteristics of each layer may be independently controlled. For instance, the composition, thickness, crystalline content, as well as the interfacial roughness between adjacent layers, may be tuned to provide a selected configuration of properties, e.g., electric permittivity, magnetic permeability, refractive indices, etc. amongst the plurality of layers.

In accordance with various embodiments, a multilayer optical coating may additionally include a barrier layer that is configured to mediate the formation of an overlying layer. For example, an amorphous, low absorption barrier layer may be formed over a crystalline optical layer within the multilayer stack and accordingly suppress crystallization of a subsequently formed optical layer thus providing phase separation between the neighboring optical layers (e.g., compositionally equivalent layers) and a desired refractive index gradient within the multilayer optical coating without adversely affecting the optical path length through the multilayer stack.

The composition of example optical layers may include both stoichiometric and non-stoichiometric compounds, such as oxides of silicon or titanium, for example. Suitable barrier layers may include magnesium fluoride, aluminum oxide, niobium oxide, tantalum oxide, etc. In some embodiments, the multilayer optical coating may have a planar architecture. In some embodiments, the multilayer optical coating may be disposed over a patterned structure.

### EXAMPLE EMBODIMENTS

Example 1: A multilayer structure includes (i) a first amorphous optical layer having a refractive index (n1), (ii) a crystalline optical layer overlying the first amorphous optical layer, the crystalline optical layer having a refractive index (n2), and (iii) an amorphous barrier layer located between the first amorphous optical layer and the crystalline optical layer, the amorphous barrier layer having a refractive index (nb).

Example 2: The multilayer structure of Example 1, where a composition of the first amorphous optical layer and a composition of the crystalline optical layer are substantially equivalent.

Example 3: The multilayer structure of any of Examples 1 and 2, where n1<n2.

Example 4: The multilayer structure of any of Examples 1-3, where n1<nb<n2.

Example 5: The multilayer structure of any of Examples 1-3, where nb<n1<n2.

Example 6: The multilayer structure of any of Examples 1-5, where the amorphous barrier layer has a thickness of less than approximately 10 nm.

Example 7: The multilayer structure of any of Examples 1-6, where the amorphous barrier layer includes a compound selected from aluminum oxide, niobium oxide, tantalum oxide, and magnesium fluoride.

Example 8: The multilayer structure of any of Examples 1-7, where the amorphous barrier layer is configured to inhibit crystallization of the first amorphous optical layer.

Example 9: The multilayer structure of any of Examples 1-8, further including a second amorphous optical layer disposed over the crystalline optical layer opposite to the amorphous barrier layer, the second amorphous optical layer having a refractive index (n3).

Example 10: The multilayer structure of Example 9, where a composition of the first amorphous optical layer, a composition of the crystalline optical layer, and a composition of the second amorphous optical layer are independently selected from silicon dioxide and titanium oxide.

Example 11: The multilayer structure of any of Examples 9 and 10, where a composition of the first amorphous optical layer and a composition of the second amorphous optical layer are substantially equivalent.

Example 12: The multilayer structure of any of Examples 9-11, where a composition of the first amorphous optical layer, a composition of the crystalline optical layer, and a composition of the second amorphous optical layer are substantially equivalent.

Example 13: The multilayer structure of any of Examples 9-12, where n1=n3.

Example 14: The multilayer structure of any of Examples 9-13, where n1=n3<n2.

Example 15: An optical waveguide including the multilayer structure of any of Examples 1-14.

Example 16: A multilayer thin film including an amorphous barrier layer disposed between a first amorphous optical layer and a crystalline optical layer, where a composition of the amorphous optical layer is substantially equivalent to a composition of the crystalline optical layer.

Example 17: The multilayer thin film of Example 16, further including a second amorphous optical layer disposed over the crystalline optical layer opposite to the amorphous barrier layer, where a refractive index of the first amorphous optical layer is substantially equal to a refractive index of the second amorphous optical layer.

Example 18: The multilayer thin film of any of Examples 16 and 17, where a refractive index of the crystalline optical layer is greater than the refractive index of the first amorphous optical layer.

Example 19: A method includes forming a crystalline optical layer over a substrate, forming an amorphous barrier layer over the crystalline optical layer, and forming an amorphous optical layer directly over the amorphous barrier layer, where a composition of the crystalline optical layer and a composition of the amorphous optical layer are substantially equivalent.

Example 20: The method of Example 19, where the amorphous barrier layer has a thickness of less than approximately 10 nm.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 500 in FIG. 5) or that visually immerses a user in an artificial reality (such as, e.g., virtual-reality system 600 in FIG. 6). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 5, augmented-reality system 500 may include an eyewear device 502 with a frame 510 configured to hold a left display device 515(A) and a right display device 515(B) in front of a user's eyes. Display devices 515(A) and 515(B) may act together or independently to present an image or series of images to a user. While augmented-reality system 500 includes two displays, embodiments of this disclosure may be implemented in augmented-reality systems with a single NED or more than two NEDs.

In some embodiments, augmented-reality system 500 may include one or more sensors, such as sensor 540. Sensor 540 may generate measurement signals in response to motion of augmented-reality system 500 and may be located on substantially any portion of frame 510. Sensor 540 may represent one or more of a variety of different sensing mechanisms, such as a position sensor, an inertial measurement unit (IMU), a depth camera assembly, a structured light emitter and/or detector, or any combination thereof. In some embodiments, augmented-reality system 500 may or may not include sensor 540 or may include more than one sensor. In embodiments in which sensor 540 includes an IMU, the IMU may generate calibration data based on measurement signals from sensor 540. Examples of sensor 540 may include, without limitation, accelerometers, gyroscopes, magnetometers, other suitable types of sensors that detect motion, sensors used for error correction of the IMU, or some combination thereof.

In some examples, augmented-reality system 500 may also include a microphone array with a plurality of acoustic transducers 520(A)-520(J), referred to collectively as acoustic transducers 520. Acoustic transducers 520 may represent transducers that detect air pressure variations induced by sound waves. Each acoustic transducer 520 may be configured to detect sound and convert the detected sound into an electronic format (e.g., an analog or digital format). The microphone array in FIG. 5 may include, for example, ten acoustic transducers: 520(A) and 520(B), which may be designed to be placed inside a corresponding ear of the user, acoustic transducers 520(C), 520(D), 520(E), 520(F), 520(G), and 520(H), which may be positioned at various locations on frame 510, and/or acoustic transducers 520(1) and 520(J), which may be positioned on a corresponding neckband 505.

In some embodiments, one or more of acoustic transducers 520(A)-(J) may be used as output transducers (e.g., speakers). For example, acoustic transducers 520(A) and/or 520(B) may be earbuds or any other suitable type of headphone or speaker.

The configuration of acoustic transducers 520 of the microphone array may vary. While augmented-reality system 500 is shown in FIG. 5 as having ten acoustic transducers 520, the number of acoustic transducers 520 may be greater or less than ten. In some embodiments, using higher numbers of acoustic transducers 520 may increase the amount of audio information collected and/or the sensitivity and accuracy of the audio information. In contrast, using a lower number of acoustic transducers 520 may decrease the computing power required by an associated controller 550 to process the collected audio information. In addition, the position of each acoustic transducer 520 of the microphone array may vary. For example, the position of an acoustic transducer 520 may include a defined position on the user, a defined coordinate on frame 510, an orientation associated with each acoustic transducer 520, or some combination thereof.

Acoustic transducers 520(A) and 520(B) may be positioned on different parts of the user's ear, such as behind the pinna, behind the tragus, and/or within the auricle or fossa. Or, there may be additional acoustic transducers 520 on or surrounding the ear in addition to acoustic transducers 520 inside the ear canal. Having an acoustic transducer 520 positioned next to an ear canal of a user may enable the microphone array to collect information on how sounds arrive at the ear canal. By positioning at least two of acoustic transducers 520 on either side of a user's head (e.g., as binaural microphones), augmented-reality device 500 may simulate binaural hearing and capture a 3D stereo sound field around about a user's head. In some embodiments, acoustic transducers 520(A) and 520(B) may be connected to augmented-reality system 500 via a wired connection 530, and in other embodiments acoustic transducers 520(A) and 520(B) may be connected to augmented-reality system 500 via a wireless connection (e.g., a BLUETOOTH connection). In still other embodiments, acoustic transducers 520(A) and 520(B) may not be used at all in conjunction with augmented-reality system 500.

Acoustic transducers 520 on frame 510 may be positioned in a variety of different ways, including along the length of the temples, across the bridge, above or below display devices 515(A) and 515(B), or some combination thereof. Acoustic transducers 520 may also be oriented such that the microphone array is able to detect sounds in a wide range of directions surrounding the user wearing the augmented-reality system 500. In some embodiments, an optimization process may be performed during manufacturing of augmented-reality system 500 to determine relative positioning of each acoustic transducer 520 in the microphone array.

In some examples, augmented-reality system 500 may include or be connected to an external device (e.g., a paired device), such as neckband 505. Neckband 505 generally represents any type or form of paired device. Thus, the following discussion of neckband 505 may also apply to various other paired devices, such as charging cases, smart watches, smart phones, wrist bands, other wearable devices, hand-held controllers, tablet computers, laptop computers, other external compute devices, etc.

As shown, neckband 505 may be coupled to eyewear device 502 via one or more connectors. The connectors may be wired or wireless and may include electrical and/or non-electrical (e.g., structural) components. In some cases, eyewear device 502 and neckband 505 may operate independently without any wired or wireless connection between them. While FIG. 5 illustrates the components of eyewear device 502 and neckband 505 in example locations on eyewear device 502 and neckband 505, the components may be located elsewhere and/or distributed differently on eyewear device 502 and/or neckband 505. In some embodiments, the components of eyewear device 502 and neckband 505 may be located on one or more additional peripheral devices paired with eyewear device 502, neckband 505, or some combination thereof.

Pairing external devices, such as neckband 505, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 500 may be provided by a paired device or shared between a paired device and an eyewear device, thus reducing the weight, heat profile, and form factor of the eyewear device overall while still retaining desired functionality. For example, neckband 505 may allow components that would otherwise be included on an eyewear device to be included in neckband 505 since users may tolerate a heavier weight load on their shoulders than they would tolerate on their heads. Neckband 505 may also have a larger surface area over which to diffuse and disperse heat to the ambient environment. Thus, neckband 505 may allow for greater battery and computation capacity than might otherwise have been possible on a stand-alone eyewear device. Since weight carried in neckband 505 may be less invasive to a user than weight carried in eyewear device 502, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 505 may be communicatively coupled with eyewear device 502 and/or to other devices. These other devices may provide certain functions (e.g., tracking, localizing, depth mapping, processing, storage, etc.) to augmented-reality system 500. In the embodiment of FIG. 5, neckband 505 may include two acoustic transducers (e.g., 520(1) and 520(J)) that are part of the microphone array (or potentially form their own microphone subarray). Neckband 505 may also include a controller 525 and a power source 535.

Acoustic transducers 520(1) and 520(J) of neckband 505 may be configured to detect sound and convert the detected sound into an electronic format (analog or digital). In the embodiment of FIG. 5, acoustic transducers 520(1) and 520(J) may be positioned on neckband 505, thereby increasing the distance between the neckband acoustic transducers 520(1) and 520(J) and other acoustic transducers 520 positioned on eyewear device 502. In some cases, increasing the distance between acoustic transducers 520 of the microphone array may improve the accuracy of beamforming performed via the microphone array. For example, if a sound is detected by acoustic transducers 520(C) and 520(D) and the distance between acoustic transducers 520(C) and 520(D) is greater than, e.g., the distance between acoustic transducers 520(D) and 520(E), the determined source location of the detected sound may be more accurate than if the sound had been detected by acoustic transducers 520(D) and 520(E).

Controller 525 of neckband 505 may process information generated by the sensors on neckband 505 and/or augmented-reality system 500. For example, controller 525 may process information from the microphone array that describes sounds detected by the microphone array. For each detected sound, controller 525 may perform a direction-of-arrival (DOA) estimation to estimate a direction from which the detected sound arrived at the microphone array. As the microphone array detects sounds, controller 525 may populate an audio data set with the information. In embodiments in which augmented-reality system 500 includes an inertial measurement unit, controller 525 may compute all inertial and spatial calculations from the IMU located on eyewear device 502. A connector may convey information between augmented-reality system 500 and neckband 505 and between augmented-reality system 500 and controller 525. The information may be in the form of optical data, electrical data, wireless data, or any other transmittable data form. Moving the processing of information generated by augmented-reality system 500 to neckband 505 may reduce weight and heat in eyewear device 502, making it more comfortable to the user.

Power source 535 in neckband 505 may provide power to eyewear device 502 and/or to neckband 505. Power source 535 may include, without limitation, lithium ion batteries, lithium-polymer batteries, primary lithium batteries, alkaline batteries, or any other form of power storage. In some cases, power source 535 may be a wired power source. Including power source 535 on neckband 505 instead of on eyewear device 502 may help better distribute the weight and heat generated by power source 535.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 600 in FIG. 6, that mostly or completely covers a user's field of view. Virtual-reality system 600 may include a front rigid body 602 and a band 604 shaped to fit around a user's head. Virtual-reality system 600 may also include output audio transducers 606(A) and 606(B). Furthermore, while not shown in FIG. 6, front rigid body 602 may include one or more electronic elements, including one or more electronic displays, one or more inertial measurement units (IMUS), one or more tracking emitters or detectors, and/or any other suitable device or system for creating an artificial-reality experience.

Artificial-reality systems may include a variety of types of visual feedback mechanisms. For example, display devices in augmented-reality system 500 and/or virtual-reality system 600 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 500 and/or virtual-reality system 600 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 500 and/or virtual-reality system 600 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

It will be understood that when an element such as a layer or a region is referred to as being formed on, deposited on, or disposed “on,” “over,” or “overlying” another element, it may be located directly on at least a portion of the other element, or one or more intervening elements may also be present. In contrast, when an element is referred to as being “directly on,” “directly over,” or “directly overlying” another element, it may be located on at least a portion of the other element, with no intervening elements present.

As used herein, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to an optical layer that comprises or includes silicon dioxide include embodiments where an optical layer consists of silicon dioxide and embodiments where an optical layer consists essentially of silicon dioxide.

What is claimed is:

1. A multilayer structure comprising:
a first amorphous optical layer having a refractive index (n1);
a crystalline optical layer overlying the first amorphous optical layer, the crystalline optical layer having a refractive index (n2); and
an amorphous barrier layer located between the first amorphous optical layer and the crystalline optical layer, the amorphous barrier layer having a refractive index (nb).

2. The multilayer structure of claim 1, wherein a composition of the first amorphous optical layer and a composition of the crystalline optical layer are substantially equivalent.

3. The multilayer structure of claim 1, wherein n1<n2.

4. The multilayer structure of claim 1, wherein n1<nb<n2.

5. The multilayer structure of claim 1, wherein nb<n1<n2.

6. The multilayer structure of claim 1, wherein the amorphous barrier layer has a thickness of less than approximately 10 nm.

7. The multilayer structure of claim 1, wherein the amorphous barrier layer comprises a compound selected from the group consisting of aluminum oxide, niobium oxide, tantalum oxide, and magnesium fluoride.

8. The multilayer structure of claim 1, wherein the amorphous barrier layer is configured to inhibit crystallization of the first amorphous optical layer.

9. The multilayer structure of claim 1, further comprising a second amorphous optical layer disposed over the crystalline optical layer opposite to the amorphous barrier layer, the second amorphous optical layer having a refractive index (n3).

10. The multilayer structure of claim 9, wherein a composition of the first amorphous optical layer, a composition of the crystalline optical layer, and a composition of the second amorphous optical layer are independently selected from the group consisting of silicon dioxide and titanium oxide.

11. The multilayer structure of claim 9, wherein a composition of the first amorphous optical layer and a composition of the second amorphous optical layer are substantially equivalent.

12. The multilayer structure of claim 9, wherein a composition of the first amorphous optical layer, a composition of the crystalline optical layer, and a composition of the second amorphous optical layer are substantially equivalent.

13. The multilayer structure of claim 9, wherein n1=n3.

14. The multilayer structure of claim 9, wherein n1=n3<n2.

15. An optical waveguide comprising the multilayer structure of claim 1.

16. A multilayer thin film comprising an amorphous barrier layer disposed between a first amorphous optical layer and a crystalline optical layer, wherein a composition of the amorphous optical layer is substantially equivalent to a composition of the crystalline optical layer.

17. The multilayer thin film of claim 16, further comprising a second amorphous optical layer disposed over the crystalline optical layer opposite to the amorphous barrier layer, wherein a refractive index of the first amorphous optical layer is substantially equal to a refractive index of the second amorphous optical layer.

18. The multilayer thin film of claim 16, wherein a refractive index of the crystalline optical layer is greater than the refractive index of the first amorphous optical layer.

19. A method comprising:
forming a crystalline optical layer over a substrate;
forming an amorphous barrier layer over the crystalline optical layer; and
forming an amorphous optical layer directly over the amorphous barrier layer, wherein a composition of the crystalline optical layer and a composition of the amorphous optical layer are substantially equivalent.

20. The method of claim 19, wherein the amorphous barrier layer has a thickness of less than approximately 10 nm.
